(19) United States
(12) Patent Application Publication
(10) Pub. No.: US 2010/0177515 A1
(43) Pub. Date: Jul. 15, 2010

(54) MODULAR LED LIGHT SYSTEM AND METHOD

(76) Inventor: Hamid Shoushtari, La Jolla, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/685,612

(22) Filed: Jan. 11, 2010

Related U.S. Application Data
(60) Provisional application No. 61/143,715, filed on Jan. 9, 2009.

(51) Int. Cl. F21S 4/00

(52) U.S. Cl. 362/249.02

(57) ABSTRACT

A modular device and system for formation of an LED based light bulb. The formed bulb is assembled from interchangeable components which adapted it for engagement to any of a plurality of conventional bulb light fixture connectors. Diffusors and hoods are also attachable to change the diffusion and focus of light emitted from the formed bulb. A plurality of different circuit boards may be engaged to a socket positioned on a heat sink to increase or decrease emitted light. The socket will only electrically engage the circuit board if the heat sink will dissipate the anticipated heat generated by the circuit board.

This application is a Continuation in Part application of U.S. Provisional Application No. 61/143,715 filed Jan. 9, 2009 which is incorporated herein in its entirety by reference.

### FIELD OF THE INVENTION

The disclosed device relates to lighting for home and commercial venues. More particularly it relates to a device and method which allow for the employment of Light Emitting Diods (LED's) as a means for projection of illumination. The device is provided in a modular form allowing for users to configure multiple types of light bulbs from interchangeable components. Employing this modular scheme, the LED's are replaceable and may be upgraded or downgraded depending on the lighting requirements in the fixture in which the device is engaged.

### BACKGROUND OF THE INVENTION

Throughout the world, the electric light bulb has provided illumination to homes and businesses for decades since the first commercial bulbs invented by Thomas Edison. Unfortunately, the modern light bulbs conventionally employed are substantially the same in design and function as the bulbs first invented by Mr. Edison, in that they employ a resistive load which creates light and heat when an electrical current is communicated across a small filament inside of a bulb housing.

These resistive bulbs consume a large amount of energy and produce an equally large amount of heat due to their resistive load nature. With energy prices ever rising, and the supply of energy such as fossil fuels becoming harder to obtain, the billions of such resistive load light bulbs, consume an inordinate amount of energy. Additionally, in homes and offices situated in climates where heat is an issue, the addition of heat from multiple light bulbs exacerbates the problem. Further, the energy consumption to both operate the light bulbs and in many cases, cool the building employing them, has become a major factor in home and business budgets. This budgetary issue can only get worse over time since the cost for electricity will continue to escalate along with the cost of fossil fuels which are employed to run generators to produce and communicate electrical power to these commercial and residential customers.

Other lighting products have met with some commercial success, such as fluorescent lights which use less energy. However, such bulbs emit light in spectrums which reflect in colors which are less desirable to consumers. These bulbs also come with their own problems such as Ultra Violet Light and Radio Frequency (RF) generation. Further, because of the nature of operation of fluorescent bulbs, the frequently come in sizes which do not adapt well to conventional screw-in and other fixtures.

More recently, LED's or light emitting diodes have emerged as a potentially new light emitting source for consumers. LED's use very little power for the comparatively huge amount of light they emit. Additionally, modern LED's have been developed to radiate in light spectrums producing colors which are much more suited to home and commercial endeavors using such lighting. Rather than the greenish spectrum emitted by fluorescent bulbs, LED's can be adapted to emit light in virtually any range.

However, virtually all LED's which conventionally have been employed for lighting are not consumer friendly. LED'S are generally hard-wired and as such, not well adapted for employment into conventional screw-in fixtures. To that end, conventionally they are not easily replaced or installed. Further, those LED fixtures which are provided for lighting purposes, are not serviceable by the user in the event of a problem or burned out bulb. Consequently, while long lasting, they usually are thrown away when they fail along with a large amount of circuitry to which they are engaged. Still further, conventional LED's used for lighting are not available in sizes conventionally adapted to home use in incandescent fixtures or for spotlights and such. When LED based lights are available, because of the circuitry and other factors involved, once sold they are generally suited only to one purpose.

As such there exists a continual unmet need for an LED-based light bulb that is adapted to engagement in conventional screw-in type fixtures. Such a bulb should emit light in spectrums that are pleasing to the consumer. Such a bulb should be serviceable by the user to replace a burned-out LED, without throwing the entire fixture away only to end up in landfills. Such a device should be adaptable to configurments in many different bulb types, from simple incandescent-type bulbs, to spotlights and floodlights through the employment of interchangeable components which are all adapted for mutual engagement, thereby providing such a means for adaptation.

The resulting device would therefor consume much less electrical power than conventional incandescent bulbs. Concurrently, while using less power, the device so configured, will provide users with numerous options for replacement, upgrades or downgrades to adapt the lumens produced. Further, such a device should employ components that are adapted to simple user configuration and reconfiguration to allow the device to be adapted to one or more light fixtures and multiple uses.

With respect to the above, before explaining at least one preferred embodiment of the invention in detail or in general, it is to be understood that the invention is not limited in its application to the details of construction and to the arrangement of the components or the steps set forth in the following description or illustrated in the drawings. The various apparatus and methods of the invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing LED-based lighting systems using components which allow for user-adaptation of the formed bulb to any, of many configurations and for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

The device disclosed in the specification and drawings herein yields a light bulb for light emission which rather than using incandescent style light generation, employs one or a plurality of LED's to emit light. The device and system herein provides such improved lighting bulbs which are adapted for employment in conventional screw-in lighting fixtures, and most other conventional bulb engagement fixtures employed across the United States and throughout the world.

The system herein and device, in one preferred mode, employs a base component having a screw-in type projection which is adapted to engage the screw-in fixtures in most desk lamps, table lamps, flood lamps, and spotlight fixtures. The base component is also provideable in other configurations adapted to engage the millions of fixtures in the installed base, world wide. The provision of such base components, which engage conventional fixtures for bulbs, insures easy adoption of the device herein and wide deployment quickly, thereby providing great ecological benefit in the reduction of power generated and fuel consumed to do so. Further, due to their long life span, easy component replacement and reconfiguration to other tasks, the device and system herein will provide great benefits in reduction of refuse destined for landfills.

The lumens emitted by the disclosed screw-in and other fixture engaging bulbs may employ LED's which emit light which emulates in illumination power and wavelength or light spectrum, the light emitted by conventional bulbs. Such conventional bulbs are usually rated in wattages such as the 60 watt bulbs which are used widely in table and desk lamps. Conventional emitted light is in wavelengths or color spectrum, commercially known as warm white, cool white, bright white, and other names which are inferential of the color of the light and reflections thereof when viewed by a user. The device and system herein meets and exceeds the ability to provide light emission at the required illumination power and colors known and depended upon by consumers. Further, unlike conventional bulbs, the device and system herein provides for adjustment of lighting output for illumination and for color by employing user-engageable circuit boards having one or different pluralities of LED's engaged thereto. Drivers are also provided to allow the user to adjust light output from an assembled component. As such, variable and increasing home and office lighting demands are easily met by the user by engaging a circuit board having an automatic driver and having more LED's, to a socket adapted to mount and electrically communicate with the circuit board and with the base component.

The mount is engaged upon a heat sink which dissipates heat communicated from the LED's through the circuit board, to the heat sink. A key component in the system is the employment of heat sink in excess of the requirements for a low-lighting LED circuit board engaged to the base. In addition to standardization of the system, it allows for subsequent user engagement of a higher light emitting circuit board having more LED's upon it. Thus, the user may upgrade lighting requirements as needed to increase output to the maximum level that the heat sink will allow.

The mounting engagement of the circuit board bearing one, or a plurality of LED's, to the socket engaged to the heat sink, may employ registered pins and the like adapted to fit only with components able to handle the heat and power requirements of the circuit board. Thus circuit boards bearing more or less LED's, using this mode of assembly, will only fit in a socket which is engaged to a heat sink of sufficient size, that it will support the dissipation of heat required for the number of LED's on the circuit board. Using this fit, non-fit, configuration, circuit boards bearing more LED's than the common heat sink will support, will not engage with the socket. By standardizing the base and socket to engage multiple circuit boards the device thus allows the user to adapt the lighting to their needs. By also configuration the component engagement to prevent insertion of an oversized LED board, the user is protected from the hazards of fire and blown circuit breakers and the like. This solves a dangerous problem present with conventional bulbs, which allow users to easily screw in a bulb drawing power and emitting heat far in excess of the rating of the fixture.

In a preferred configuration, a housing engaged on a first end with the base, has a threaded engagement on an opposite end. This threaded engagement is adapted to engage with one or a plurality of different diffusion components. The diffusion components will allow the user to adapt the formed bulb to many different configurations such as a spotlight, a flood light, or a bulb similar in size and radiating patterns as a conventional incandescent bulb. Thus, by engaging any of a kit of diffusion components, and any of a plurality of different numbers of LED's on different circuit boards engageable to the common base, the user may adapt the formed bulb, to fit virtually any conventional light fixture, for any conventional use.

The foregoing has outlined rather broadly the more pertinent and important features of the device and method herein employing LED's on circuit boards that engage with sockets on heat sinks and having engageable diffusion components in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other modular components for LED light bulbs for carrying out the same purposes of the present invention. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### THE OBJECTS OF THE INVENTION

It is therefore an object of the present invention to provide a user-configurable LED based light bulb, that is configurable to many different light output levels.

It is another object of this invention to provide such an LED based bulb, that also provides a plurality of engageable diffusion components thereby providing a means to adapt the bulb to many uses in conventional fixtures.

It is a further object of this invention, to provide an LED lighting system, which is employable in kit form wherein a single base component is engageable to a plurality of LED components of varying light emission ability.

It is yet a further object of this invention, to provide an assembleable LED based light bulb, which may be adapted to engage any of a plurality of different types of conventional fixtures to insure easy and rapid deployment in the installed base of such fixtures.

It is another object of this invention, to provide such a kit or user-assembled lighting system, wherein only LED components, which do not exceed the heat sink cooling capability of the base, may be assembled to allow for safe user configuration to the lighting need and fixture.

The foregoing has outlined some of the more pertinent objects of the invention. These objects should be construed to be merely illustrative of some of the more prominent features and applications of the intended invention. Many other beneficial results can be attained by applying the disclosed method and device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a sliced view of the device showing a base component which is adapted to engage a conventional screw-in fixture and the engaged LED circuit board, electrically engaged in a socket contacting a heat sink.

FIG. 2 shows the bulb of FIG. 1 with an exterior housing surrounding the internal components of FIG. 1.

FIG. 3 is a perspective view of FIG. 1 with a simple spotlight type diffuser or lens engaged to the end opposite the screw-in component.

FIG. 4 is a top view of FIG. 1.

FIG. 5 is an exploded view of the device in FIGS. 1-4.

FIG. 6 shows a further exploded view of FIG. 5 rotated 90 degrees, showing the heat sink is adapted for a circuit board bearing more LED's than FIG. 5.

FIG. 7 is a side view of the device of FIG. 1, showing the engageable diffuser in the form of a spot or flood type hood engaged to the distal end of the housing.

FIG. 8 depicts a side view of FIG. 7.

FIG. 9 shows a perspective view of FIG. 8.

FIG. 10 shows an end view of FIG. 8.

FIG. 11 depicts another mode of the device configurable as a different PAR-type spot or flood light.

FIG. 12 depicts the device of FIG. 11 rotated and showing the heat sink engageable with the LED circuit board bearing more LED's for higher output of light.

FIG. 13 depicts another mode of the device configured for a different PAR-style bulb.

FIG. 14 shows an exterior view of FIG. 13.

FIG. 15 depicts a perspective view of FIG. 14.

FIG. 16 is an end view of FIG. 14 with hood attached.

FIG. 17 shows the device with the base having a globe type light diffuser at the distal end of the housing to form an incandescent bulb style from the assembled components.

FIG. 18 depicts base components adapted to fit with conventional florescent fixtures which engage with the other components to allow use is conventional fluorescent fixtures.

FIG. 19 depicts the various configurations of other screw, insertion, and bayonet style electrical conductors for base for provision of electrical power for the rest of the disclosed modular components.

### DETAILED DESCRIPTION OF THE PREFERRED EMBODIMENTS

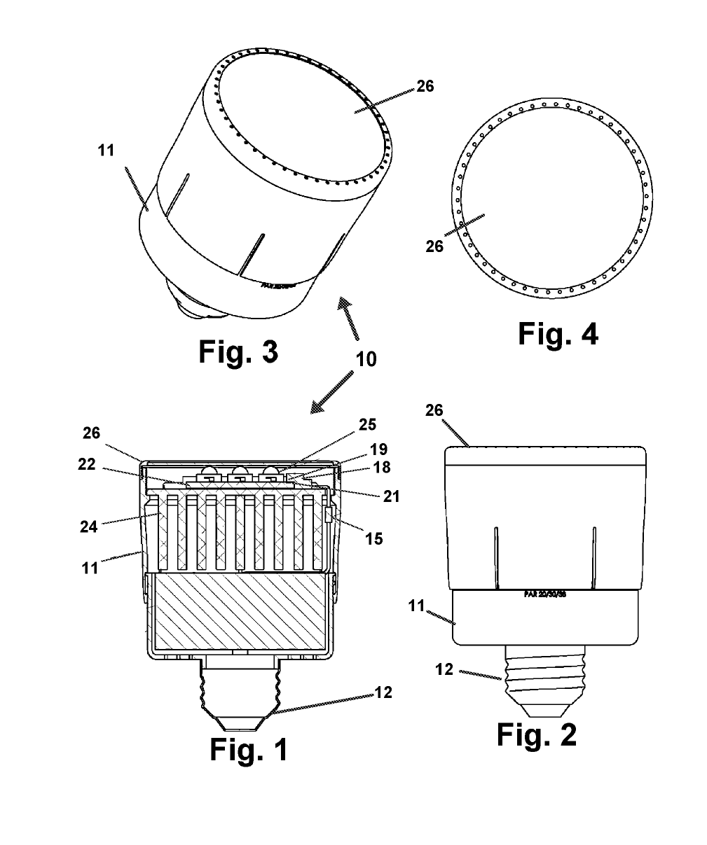

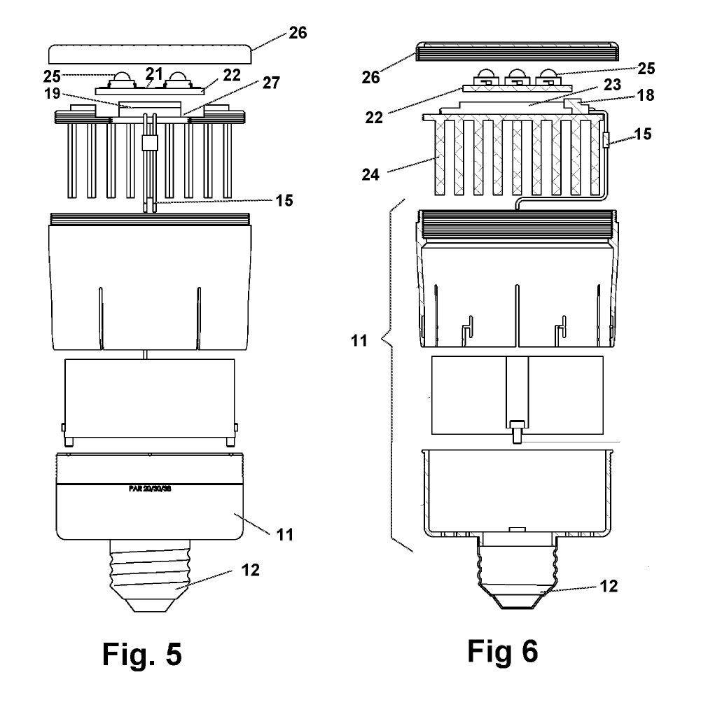

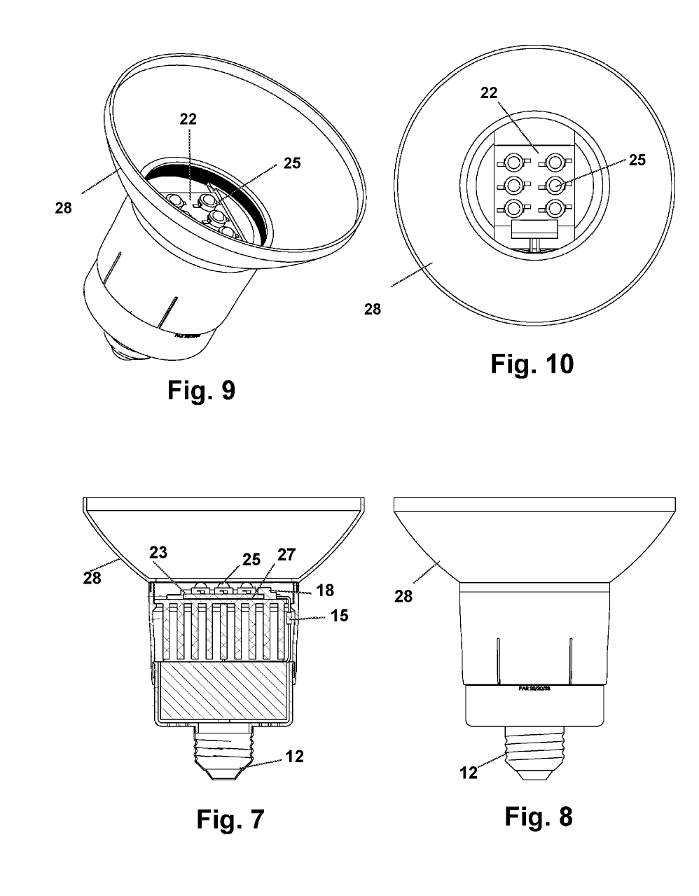

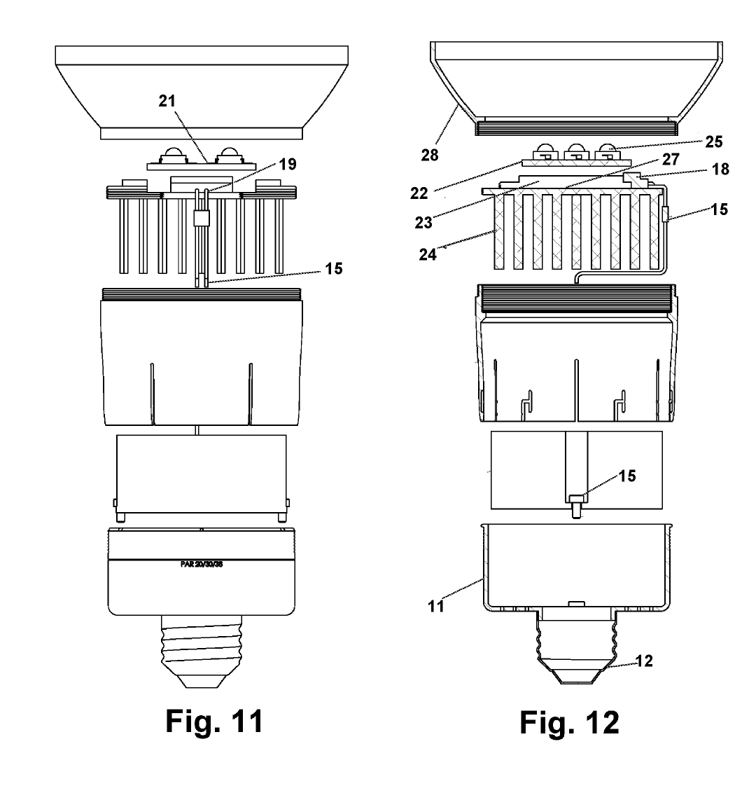

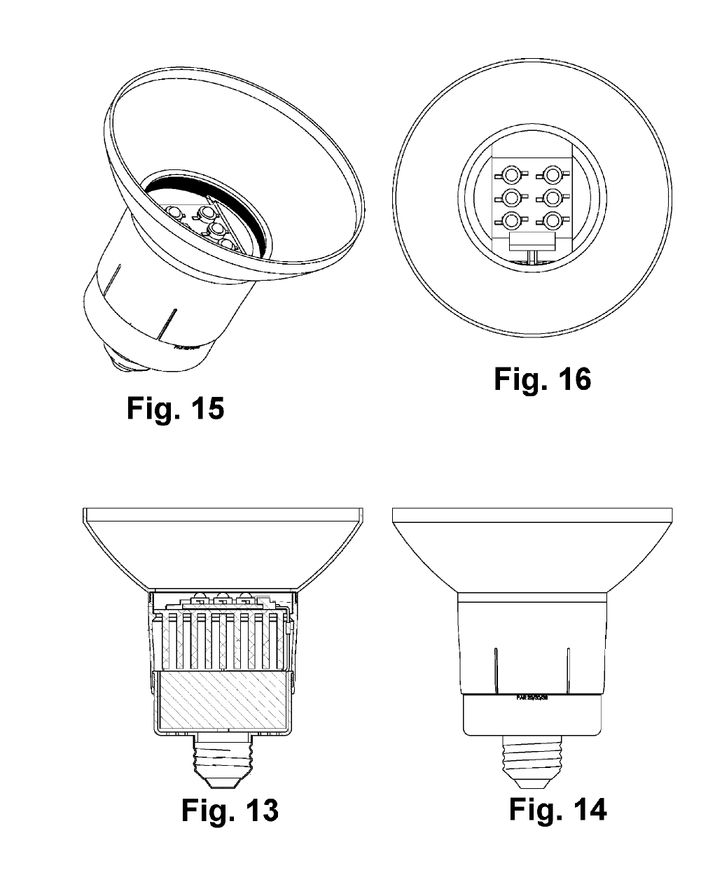

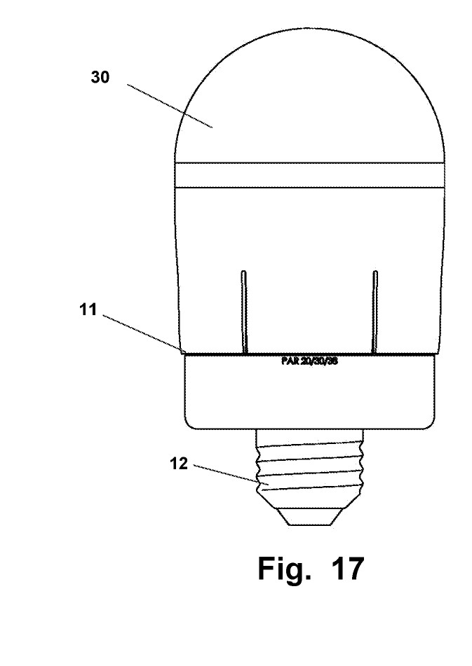

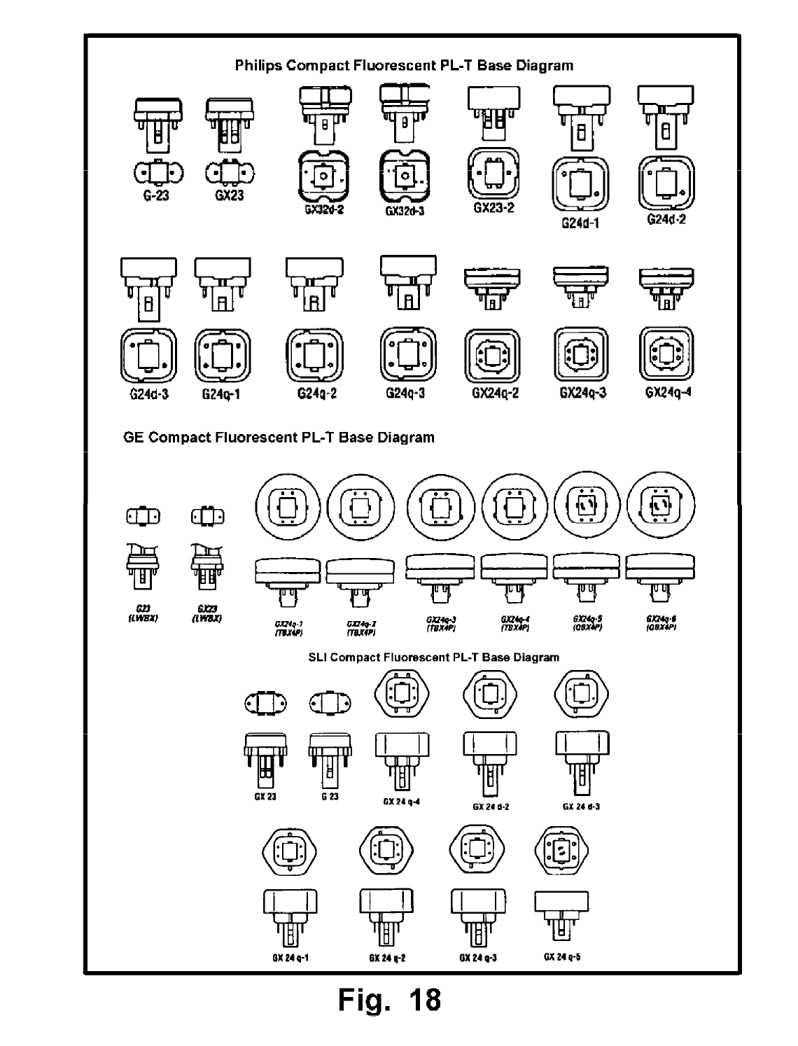

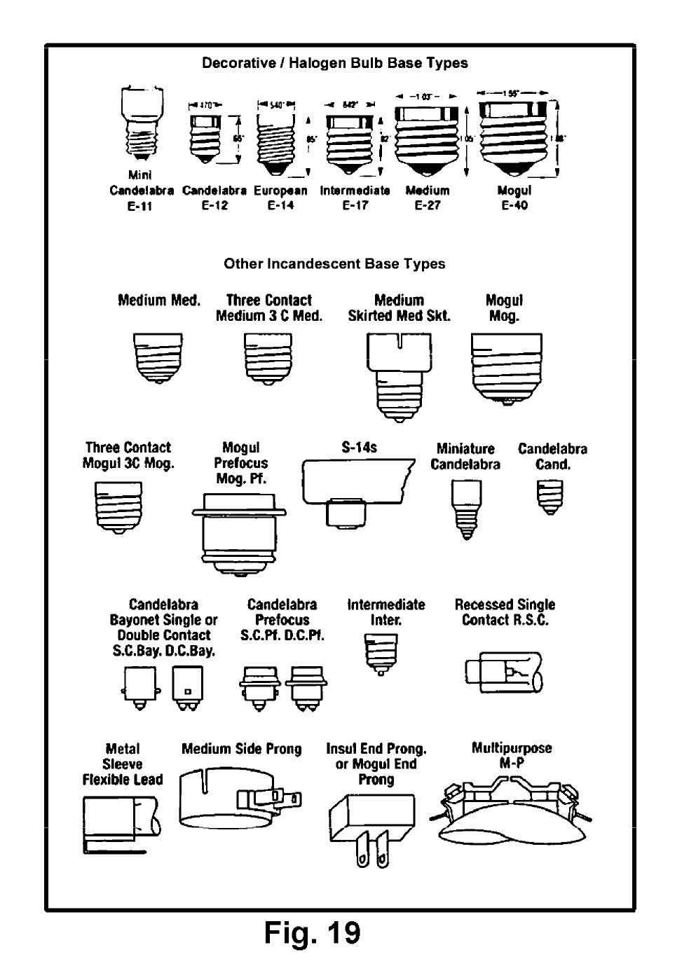

Referring now to the drawings 1-19, wherein similar parts of the invention are identified by like reference numerals, there is seen in FIG. 1 the base 11, having a means for electrical engagement with a lighting fixture shown in the form of a conventional screw in electrical engagement component 12. Of course any means for operative engagement with a conventional light fixture, such as those depicted in FIGS. 18 and 19, may be employed so as to provide electrical power to the device 10 and allow engagement into conventional fixtures. This will insure wide deployment in a short time and increased ecological benefit from reduced energy use.

The base 11 so engaged communicates power from the fixture engaged with the engagement component 12 using wires 15 or other electrical means to communicate electrical power to a housing 18 which employs electrical contacts 19 in positions to register and engage with mating contacts 21 on the circuit board 22.

The employment of circuit boards 22 for electrical communication and control of LED's is well known and need not be discussed. The circuit boards 22 act as drivers for the LED's and bear conventional electronic components to provide power to the LED's 25. They may be adapted to electronically control the light emitted by the LED's from brighter to dimmer.

Means for removable engagement of the housing 18 with the circuit board 22 are provided by a socket or slot 23 in the housing 18. The circuit board 22 is pushed into the slot 23 wherein the electrical contacts 19 and 21 align and communicate power from the engagement component 12 to the LED's 25 on the circuit board 22. Of course other means for removable engagement may be employed as well as electrical communication, and all as would occur to those skilled in the are considered within the scope of this invention. The slot 23 and contacts 19 and 21 provide a particularly preferred means to prevent insertion of a circuit board 22 having too many LED's 25 thereon by forming the slot 23 and positioning the contacts 19 and 21, to only allow insertion of circuit boards 22 bearing a plurality of LED's which may be cooled by the heat sink 24 positioned to tightly contact the circuit board 22.

Further, the slot 23 engagement also provides a means to tightly contact the rear of the circuit board 22 with the planar face 27 of the heat sink 24 to maximize heat transmission from the LED's to the heat sink 24 during use. The slot 23 thereby thermally engages the circuit board 22 to the heat sink 24. The heat sink 24 is adapted in size to dissipate the heat generated by the number of LED's 25 engaged to the circuit board 22 which will fit in the slot 23 and align their respective contacts 19 and 21. This engagement to the heat sink 24 provides means to prevent insertion of a circuit board 22 bearing too many LED's 25 and to also allow for maximum thermal conduction from the LED's 25 to the heat sink 24. As depicted in all of the drawings, the socket provided by the slot is adapted to only accept circuit boards 22 bearing a number of LED's 25 for which the heat sink 24 will dissipate heat and it will reject circuit boards 22 bearing too many LED's 25.

The device 10 thus may be provided in a kit form, or as individual user assembled parts, such that should the user need more light at a later date, and new circuit board 22 bearing more LED's 25 may be obtained and engaged in the slot 23. Should lighting needs change, or fixtures, the other components shown herein may be substituted for each other to allow for different fixture engagements and different light transmission schemes.

Engageable diffusion components such as lens 26, hood 28, and the globe 30 in FIG. 17, are user-engageable and are adapted for easy engagement by the user to the device 10 to change its light focus and/or dissipation to adapt the device 10 to many different uses as noted. If needed due to failure or user requirements, the LED's 25 may be easily replaced by inserting a new circuit board 22 into the socket formed by the slot 23. In this fashion light emission may be increased or decreased by simply inserting circuit boards 22 with more or less LED's 25 or of different colors.

The base 11 may also be adapted with means of electrical engagement with a light fixture, by substituting the screw-in type electrical engagement component 12 with another adapted to fit with and communicate electrical power from the light fixture. FIGS. 18-19 depict some of the configurations for the engagement component 12 of the base 11 which allow the device 10 to be employed quickly with existing fixtures.

While all of the fundamental characteristics and features of the disclosed LED based component light bulb device have been described herein, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

Further, the purpose of the herein disclosed abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A modular system for formation of an LED based light bulb adapted for engagement to a light fixture connector which communicates electricity to a conventional incandescent or fluorescent light bulb, comprising:
a base having a first end and a second end;
means for electrical engagement to said connector on or adjacent to said first end of said base;
a housing having an engagement end and distal end;
means for engagement of said engagement end to said base to an attached position;
a heat sink positioned within or adjacent to said distal end of said housing, said heat sink having a planar portion adjacent to said distal end of said housing;
a circuit board, said circuit board having a first side surface and second side surface, said circuit board having means for illumination positioned thereon, said means for illumination being one or a plurality of LED's operatively positioned on said first side surface of said circuit board;
means for engagement of said circuit board to an attached position;
said circuit board in said attached position placing said second side surface in a contact with said planar portion of said heat sink;
said contact with said planar portion providing means to communicate a portion of said heat generated by said means for illumination, to said heat sink; and
means to communicate said electricity from said means for electrical engagement, to said LED's forming said means for illumination upon said circuit board, only when said circuit board is placed in said attached position.

2. The modular system of claim 1, additionally comprising:
said circuit board being a member of a kit of a plurality of said circuit boards, each of said plurality featuring a said means for illumination formed of a different plurality of said LED's operatively engaged to said first side surface; and
means to prevent said means to communicate said electricity from said means for electrical engagement, to said LED's forming said means for illumination, should said portion of said heat generated by said means for illumination exceed a level safely communicable to said heat sink.

3. The modular system of claim 1, additionally comprising:
means to focus light emitted by said means for illumination, said means to focus being removably engageable at said distal end of said housing, whereby said light emitted by said means for illumination can be focused or diffused to thereby form a user-determined area of illumination.

4. The modular system of claim 2, additionally comprising:
means to focus light emitted by said means for illumination, said means to focus being removably engageable at said distal end of said housing, whereby said light emitted by said means for illumination can be focused or diffused to thereby form a user-determined area of illumination.

5. The modular system of claim 3, additionally comprising:
said means to focus light being a member of a kit of light focusing components, said kit including, diffusors, reflectors and lenses, whereby said light emitted by said means for illumination can be focused or diffused by a chosen of said light focusing components, to thereby form a user-determined area of illumination.

6. The modular system of claim 4, additionally comprising:
said means to focus light being a member of a kit of light focusing components, said kit including, diffusors, reflectors and lenses, whereby said light emitted by said means for illumination can be focused or diffused by a chosen of said light focusing components, to thereby form a user-determined area of illumination.

7. The modular system of claim 1, wherein said means for electrical engagement to said connector is a screw-in component, said screw-in component being rotatably engageable with a socket forming said connector.

8. The modular system of claim 2, wherein said means for electrical engagement to said connector is a screw-in component, said screw-in component being rotatably engageable with a socket forming said connector.

9. The modular system of claim 3, wherein said means for electrical engagement to said connector is a screw-in component, said screw-in component being rotatably engageable with a socket forming said connector.

10. The modular system of claim 4, wherein said means for electrical engagement to said connector is a screw-in component, said screw-in component being rotatably engageable with a socket forming said connector.

11. The modular system of claim 5, wherein said means for electrical engagement to said connector is a screw-in component, said screw-in component being rotatably engageable with a socket forming said connector.

12. The modular system of claim 6, wherein said means for electrical engagement to said connector is a screw-in component, said screw-in component being rotatably engageable with a socket forming said connector.

13. The modular system of claim 1 wherein said means for electrical engagement to said connector is a member of a kit of said means for electrical engagement to said connector; and
each member of said kit configured to engaged a different said connector.

14. The modular system of claim 2 wherein said means for electrical engagement to said connector is a member of a kit of said means for electrical engagement to said connector; and
each member of said kit configured to engaged a different said connector.

15. The modular system of claim 3 wherein said means for electrical engagement to said connector is a member of a kit of said means for electrical engagement to said connector; and
each member of said kit configured to engaged a different said connector.

16. The modular system of claim 4 wherein said means for electrical engagement to said connector is a member of a kit of said means for electrical engagement to said connector; and
each member of said kit configured to engaged a different said connector.

17. The modular system of claim 5 wherein said means for electrical engagement to said connector is a member of a kit of said means for electrical engagement to said connector; and
each member of said kit configured to engaged a different said connector.

18. The modular system of claim 6 wherein said means for electrical engagement to said connector is a member of a kit of said means for electrical engagement to said connector; and
each member of said kit configured to engaged a different said connector.
